(19) United States
(12) Patent Application Publication
(10) Pub. No.: US 2014/0183999 A1
(43) Pub. Date: Jul. 3, 2014

(54) SPINDLE MOTOR

(71) Applicant: SAMSUNG ELECTRO-MECHANICS CO., LTD., Suwon (KR)

(72) Inventor: Viatcheslav SMIRNOV, Suwon (KR)

(73) Assignee: Samsung Electro-Mechanics Co., Ltd., Suwon (KR)

(21) Appl. No.: 13/795,151

(22) Filed: Mar. 12, 2013

(30) Foreign Application Priority Data
Dec. 28, 2012 (KR) 10-2012-0156966

(51) Int. Cl. H02K 7/08; H02K 1/27

(52) U.S. Cl. CPC H02K 7/08; H02K 1/2786
USPC 310/90

(57) ABSTRACT

There is provided a spindle motor including: a rotating member including a shaft having a fixation groove provided in a lower portion thereof, a hub base extended from an upper end of the shaft in an outer radial direction, and a magnet support part extended downwardly from an outer edge of the hub base in an axial direction; a sleeve rotatably supporting the rotating member and including a reception groove depressed downwardly from an upper surface thereof in the axial direction; and a stopper member including a fixation part inserted into the fixation groove and a flange part extended from the fixation part in the outer radial direction, wherein the hub base includes a protrusion part protruding from one surface of the hub base and received in the reception groove.

### CROSS-REFERENCE TO RELATED APPLICATIONS

This application claims the priority of Korean Patent Application No. 10-2012-0156966 filed on Dec. 28, 2012, in the Korean Intellectual Property Office, the disclosure of which is incorporated herein by reference.

### BACKGROUND OF THE INVENTION

1. Field of the Invention

The present invention relates to a spindle motor.

2. Description of the Related Art

A hard disk drive (HDD), an information storage device, reads data stored on a disk or writes data to a disk using a read/write head.

The hard disk drive requires a disk driving device capable of driving the disk. In a disk driving device, a spindle motor is commonly used.

This spindle motor uses a hydrodynamic bearing assembly. A shaft, a rotating member of the hydrodynamic bearing assembly, and a sleeve, a fixed member thereof, have a lubricating fluid interposed therebetween, such that the shaft is supported by fluid pressure generated in the lubricating fluid.

In this case, the lubricating fluid injected into the hydrodynamic bearing assembly may be leaked to the outside by an external impact or an amount thereof may be reduced by evaporation. Due to this phenomenon, the hydrodynamic bearing may not generate pressure, and consequently, a problem in terms of the performance and lifespan of the spindle motor may be generated.

In addition, in the case in which an external impact, or the like, is applied during the driving of a spindle motor, internal components may be deformed, which may have a negative influence on the driving of the spindle motor. Therefore, it may be important to secure rigidity of the spindle motor.

Therefore, research into a technology of improving the rigidity of a spindle motor so that internal components thereof are not deformed, even in the case that an external impact, or the like, is transmitted thereto, and of securing a storage space for lubricating fluid to significantly increase performance and lifespan of a spindle motor, has been urgently demanded.

### SUMMARY OF THE INVENTION

An aspect of the present invention provides a spindle motor having improved rigidity and an increased storage space for a lubricating fluid.

An aspect of the present invention also provides a spindle motor allowing for a simplified manufacturing process and decreasing manufacturing costs by decreasing the number of internal components of the spindle motor.

Further, an aspect of the present invention also provides a spindle motor capable of increasing a magnitude of hydrodynamic pressure and improving resistance against external impacts, or the like.

According to an aspect of the present invention, there is provided a spindle motor including: a rotating member including a shaft having a fixation groove provided in a lower portion thereof, a hub base extended from an upper end of the shaft in an outer radial direction, and a magnet support part extended downwardly from an outer edge of the hub base in an axial direction; a sleeve rotatably supporting the rotating member; and a stopper member including a fixation part inserted into the fixation groove and a flange part extended from the fixation part in the outer radial direction, wherein opposite surfaces of the flange part and the sleeve are inclined.

The flange part may be extended outwardly of an outer peripheral surface of the shaft in the outer radial direction, and an outer edge of the flange part may be opposite to a lower end of an inner peripheral surface of the sleeve.

The sleeve may include a reception groove depressed downwardly from an upper surface thereof in the axial direction, and the hub base may include a protrusion part protruding from one surface of the hub base and received in the reception groove.

A lubricating fluid may be sealed between an inner peripheral surface of the protrusion part and a surface of the sleeve opposite to the inner peripheral surface of the protrusion part.

At least one of the inner peripheral surface of the protrusion part and the opposite surface of the sleeve may be tapered so as to seal the lubricating fluid.

A lubricating fluid may be sealed between a lower surface of the protrusion part and a surface of the sleeve opposite to the lower surface of the protrusion part.

At least one of the lower surface of the protrusion part and the opposite surface of the sleeve may be tapered so as to seal the lubricating fluid.

The sleeve may be provided with a bypass channel penetrating through upper and lower portions of the sleeve.

According to another aspect of the present invention, there is provided a spindle motor including: a rotating member including a shaft, a hub base extended from an upper end of the shaft in an outer radial direction, and a magnet support part extended downwardly from an outer edge of the hub base in an axial direction; a stopper part coupled to a lower portion of the shaft; and a sleeve rotatably supporting the shaft and including a reception groove depressed downwardly from an upper surface thereof in the axial direction; wherein the hub base includes a protrusion part protruding from one surface of the hub base and received in the reception groove, and opposite surfaces of the stopper part and the sleeve are inclined.

According to another aspect of the present invention, there is provided a spindle motor including: a rotating member including a shaft, a hub base extended from an upper end of the shaft in an outer radial direction, and a magnet support part extended downwardly from an outer edge of the hub base in an axial direction; a shaft housing including a housing coupled to the shaft and a stopper part extended from a lower portion of the housing in the outer radial direction; and a sleeve rotatably supporting the shaft and including a reception groove depressed downwardly from an upper surface thereof in the axial direction; wherein the hub base includes a protrusion part protruding from one surface of the hub base and received in the reception groove, and opposite surfaces of the stopper part and the sleeve are inclined.

At least one of an outer peripheral surface of the housing and an inner peripheral surface of the sleeve may be provided with a radial dynamic pressure groove generating radial dynamic pressure.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view of a spindle motor according to an embodiment of the present invention;

FIG. 2 is an enlarged cross-sectional view of part A of FIG. 1;

FIG. 3 is a half cross-sectional view showing a modified example of a taper structure for sealing a lubricating fluid in the spindle motor according to the embodiment of the present invention;

FIG. 4 is a half cross-sectional view showing another modified example of the taper structure for sealing the lubricating fluid in the spindle motor according to the embodiment of the present invention;

FIG. 5 is a half cross-sectional view showing another modified example of the taper structure for sealing the lubricating fluid in the spindle motor according to the embodiment of the present invention;

FIG. 6 is a half cross-sectional view showing another modified example of the taper structure for sealing the lubricating fluid in the spindle motor according to the embodiment of the present invention;

FIG. 7A is a half cross-sectional view showing a modified example of a sealing position of the lubricating fluid in the spindle motor according to the embodiment of the present invention;

FIG. 7B is a half cross-sectional view showing a state in which an interface between the lubricating fluid and air is moved due to evaporation of the lubricating fluid during the driving of the spindle motor according to the embodiment of the present invention;

FIG. 8 is a half cross-sectional view showing a modified example of an inclined structure of opposite surfaces of a stopper member and a sleeve in the spindle motor according to the embodiment of the present invention;

FIG. 9 is a half cross-sectional view showing another modified example of the inclination structure of the opposite surfaces of the stopper member and the sleeve in the spindle motor according to the embodiment of the present invention;

FIG. 10 is a half cross-sectional view showing another modified example of the inclination structure of the opposite surfaces of the stopper member and the sleeve in the spindle motor according to the embodiment of the present invention;

FIG. 11 is a half cross-sectional view of a spindle motor according to another embodiment of the present invention; and

FIG. 12 is a half cross-sectional view of a spindle motor according to another embodiment of the present invention.

### DETAILED DESCRIPTION OF THE EMBODIMENTS

Hereinafter, embodiments of the present invention will be described in detail with reference to the accompanying drawings.

The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the shapes and dimensions of components maybe exaggerated for clarity, and the same reference numerals will be used throughout to designate the same or like components.

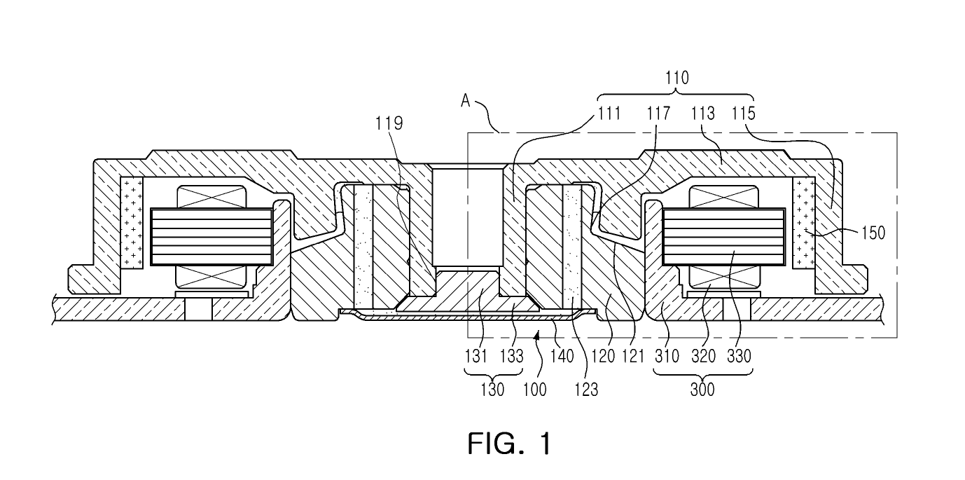

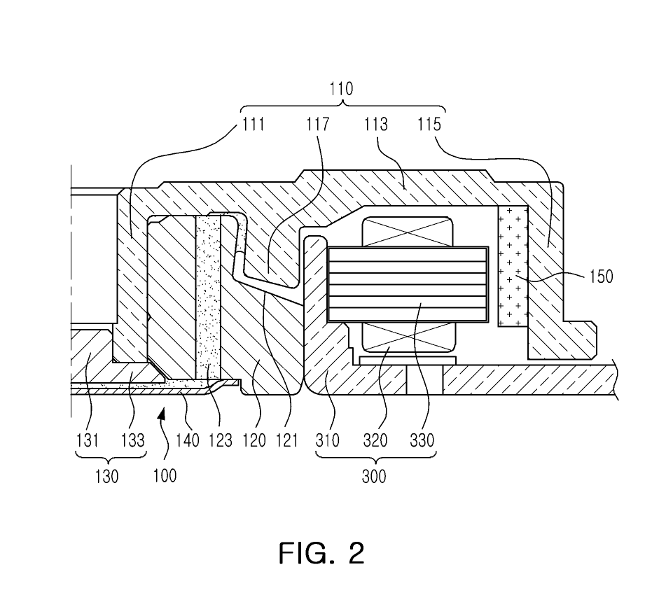

FIG. 1 is a schematic cross-sectional view showing a spindle motor according to an embodiment of the present invention; and FIG. 2 is an enlarged cross-sectional view of part A of FIG. 1.

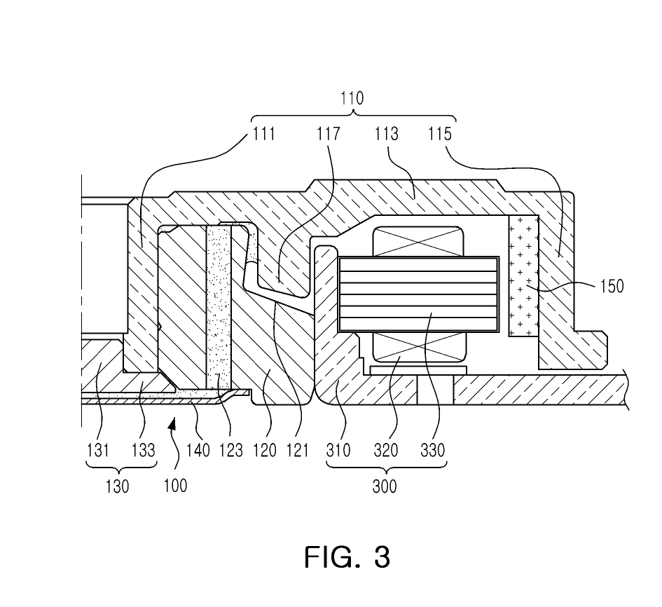

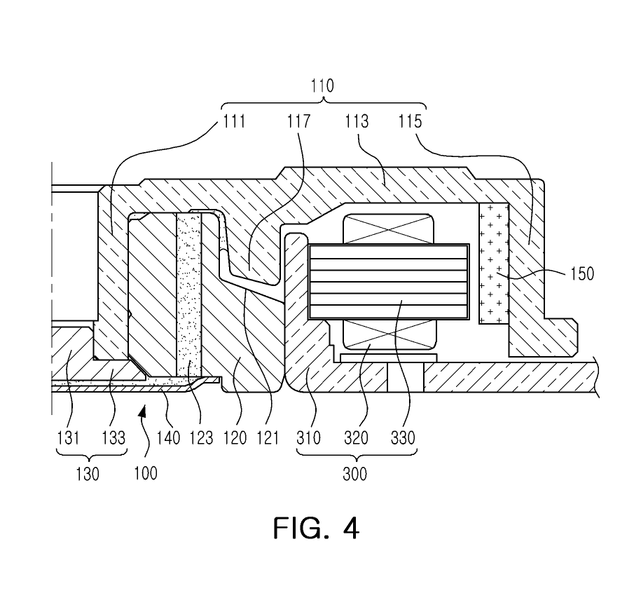

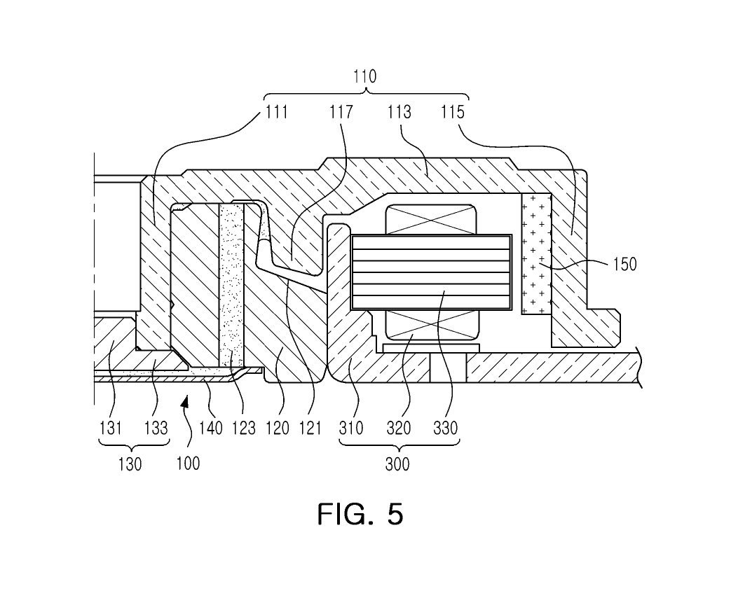

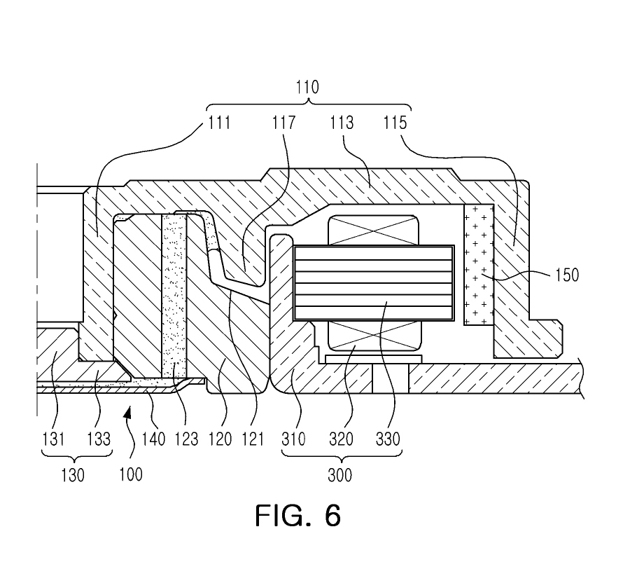

FIGS. 3 through 6 are half cross-sectional views showing modified examples of a taper structure for sealing a lubricating fluid in the spindle motor according to the embodiment of the present invention.

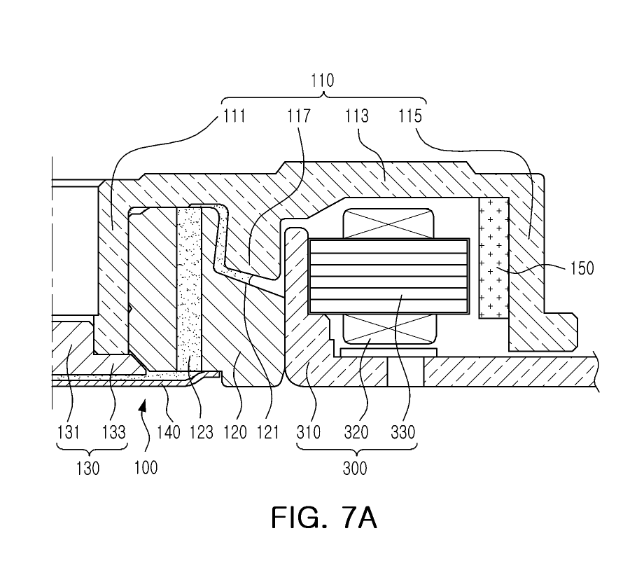

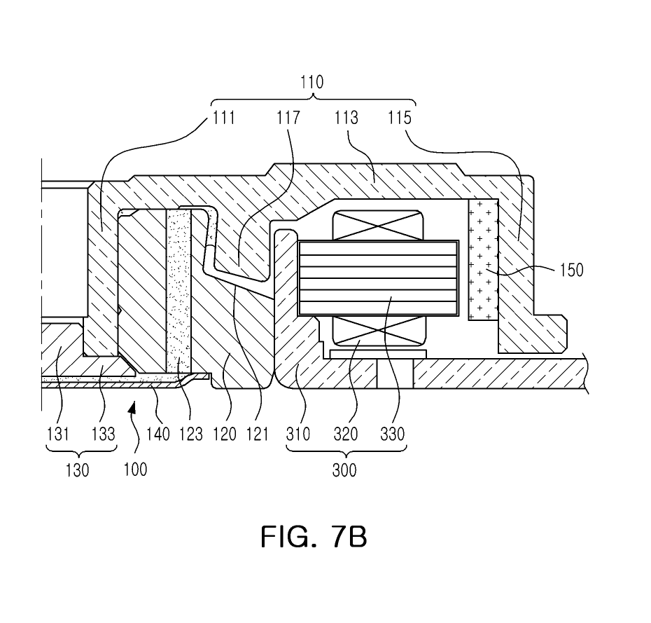

In addition, FIG. 7A is a half cross-sectional view showing a modified example of a sealing position of the lubricating fluid in the spindle motor according to the embodiment of the present invention, and FIG. 7B is a half cross-sectional view showing a state in which an interface between the lubricating fluid and air is moved due to evaporation of the lubricating fluid during the driving of the spindle motor according to the embodiment of the present invention.

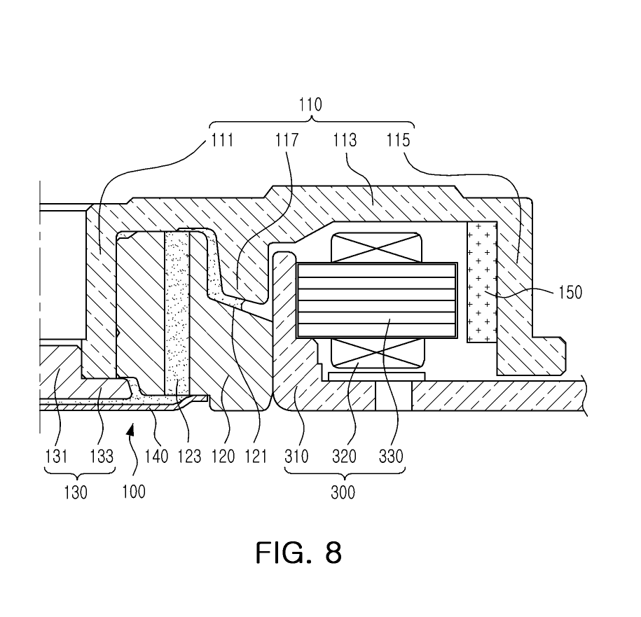

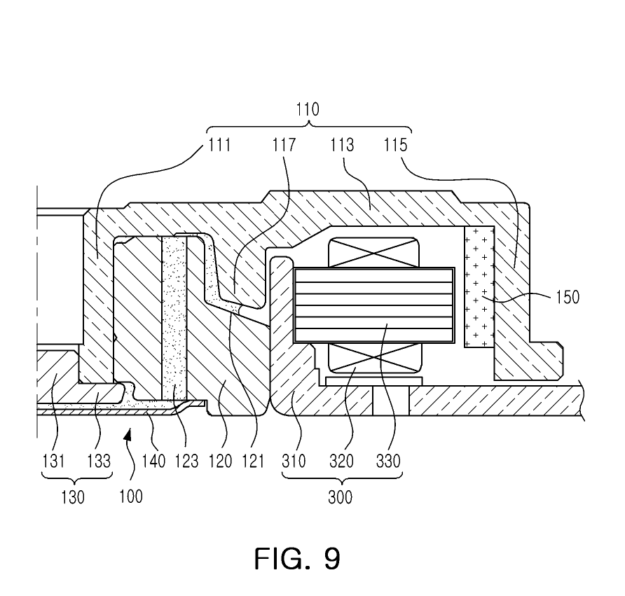

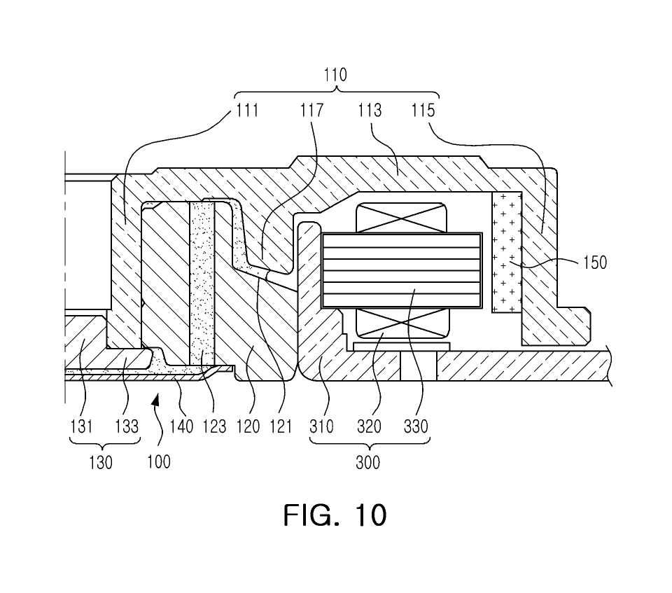

FIGS. 8 through 10 are half cross-sectional views showing modified examples of an inclination structure of opposite surfaces of a stopper member and a sleeve in the spindle motor according to the embodiment of the present invention.

Referring to FIGS. 1 through 10, the spindle motor according to the embodiment of the present invention may include a hydrodynamic bearing assembly 100 and a stator 300, a fixed member.

Terms with respect to directions will be first defined. As viewed in FIG. 1, an axial direction refers to a vertical direction based on a shaft 111, and an outer or inner radial direction refers to a direction towards an outer edge of the shaft 111 based on the shaft 111 or a direction towards the center of the shaft 111 based on the outer edge of the shaft 111.

The hydrodynamic bearing assembly 100 may include a rotating member 110 including the shaft 111, a sleeve 120, a stopper member 130, and a cover plate 140.

The shaft 111 may configure the rotating member 110 together with a hub base 113 and a magnet support part 115 and rotate relatively with respect to the fixed member.

The rotating member 110 may include the shaft 111 inserted into a shaft hole of the sleeve 120, the hub base 113 extended from an upper end of the shaft 111 in the outer radial direction, and the magnet support part 115 extended downwardly from an outer edge of the hub base 113 in the axial direction.

The shaft, the hub base, and the magnet support part may be separately prepared and be coupled to each other to configure the rotating member, but in the spindle motor according to the embodiment of the present invention, the shaft 111, the hub base 113, and the magnet support part 115 may be formed integrally with each other to configure the rotating member 110.

In the case in which the shaft 111, the hub base 113, and the magnet support part 115 are formed integrally with each other to configure the rotating member 110, repeatable run out (RRO) maybe decreased to thereby minimize micro vibrations and significantly increase performance.

Further, in the case in which separate members are coupled to each other to configure a rotating member, when external impacts, or the like, are applied to a coupling portion between the members, deformation of internal components may occur. However, in the spindle motor according to the embodiment of the present invention, the shaft 111, the hub base 113, and the magnet support part 115 may be formed integrally with each other, so that deformation of the internal components may be suppressed even when the external impacts, or the like, are applied.

The rotating member 110 is a rotational structure provided to be rotatable with respect to the stator 300 and may include an annular ring shaped magnet 150 on an inner peripheral surface thereof so as to correspond to a core 330, having a predetermined interval therebetween.

The magnet support part 115 provided in the rotating member 110 may be bent downwardly from the hub base 113 in the axial direction to support the magnet 150.

In addition, the magnet 150 may be a permanent magnet generating magnetic force having a predetermined strength by alternately magnetizing an N pole and an S pole thereof in a circumferential direction.

Here, rotational driving of the rotating member 110 will be schematically described. When power is supplied to a coil 320 wound around the core 330, driving force capable of rotating the rotating member 110 may be generated by electromagnetic interaction between the magnet 150 and the core 330 having the coil 320 wound therearound.

Therefore, the rotating member 110 may rotate relatively with respect to the fixed member.

Meanwhile, the hub base 113 configuring the rotating member 110 may include a protrusion part 117 protruding downwardly from one surface of the hub base 113 in the axial direction.

The protrusion part 117 may be received in a reception groove 121 formed in the sleeve 120, the fixed member, and the lubricating fluid may be sealed between the protrusion part 117 and the reception groove 121.

A detailed description thereof will be provided below.

The sleeve 120 may support the shaft 111 so that the shaft 111 may rotate and may be formed by forging Cu or Al or sintering Cu—Fe based alloy powders or SUS based powders.

Here, the shaft 111 may be inserted into the shaft hole of the sleeve 120 while having a micro clearance therebetween. The micro clearance may be filled with a lubricating fluid, and the rotation of the shaft 111 may be more smoothly supported by a radial dynamic pressure groove (not shown) formed in at least one of an outer diameter portion of the shaft 111 and an inner diameter portion of the sleeve 120.

The radial dynamic pressure groove (not shown) may be formed in an inner peripheral surface of the sleeve 120, an inner portion of the shaft hole of the sleeve 120, and generate pressure so that the shaft 111 may smoothly rotate in a state in which the shaft 111 is spaced apart from the inner peripheral surface of the sleeve 120 by a predetermined interval at the time of rotation of the shaft 111.

However, the radial dynamic pressure groove (not shown) is not limited to being formed in the inner peripheral surface of the sleeve 120 as described above, but may also be formed in an outer peripheral surface of the shaft 111. In addition, the number of radial dynamic pressure grooves is not limited.

The radial dynamic pressure groove (not shown) may have any one of a herringbone shape, a spiral shape, and a helical shape. However, the radial dynamic pressure groove (not shown) may have any shape as long as radial dynamic pressure may be generated.

In addition, a thrust dynamic pressure groove (not shown) may be formed in at least one of an upper surface of the sleeve 120 and one surface of the hub base 113 of the rotating member opposite to the upper surface of the sleeve 120, and the shaft 111 may rotate in a state in which a predetermined amount of floating force is secured by the thrust dynamic pressure groove (not shown).

Here, the thrust dynamic pressure groove (not shown) may have a herringbone shape, a spiral shape, or a helical shape, similar to the radial dynamic pressure groove (not shown). However, the thrust dynamic pressure groove (not shown) is not necessarily limited to having the above-mentioned shape, but may have any shape as long as thrust dynamic pressure may be provided.

Further, the sleeve 120 may have at least one bypass channel 123 allowing upper and lower portions of the sleeve 120 to be in communication with each other.

The bypass channel 123 may be provided in various shapes so as to allow the upper and lower portions of the sleeve 120 to be in communication with each other.

The bypass channel 123 may disperse pressure from the lubricating fluid to maintain a balance in the pressure and may move air bubbles, or the like, present in the lubricating fluid so as to be discharged by circulation.

Meanwhile, an upper surface of the sleeve 120 may be provided with the reception groove 121 depressed inwardly, and the protrusion part 117 protruding from one surface of the hub base 113 may be received in the reception groove 121.

The protrusion part 117 and the reception groove 121 may include a micro clearance formed therebetween, and the lubricating fluid may be sealed between the protrusion part 117 and the reception groove 121.

To this end, as shown in FIGS. 2 through 6, at least one of an inner peripheral surface of the protrusion part 117 and a surface of the sleeve 120 opposite to the inner peripheral surface of the protrusion part 117 may be tapered.

However, a sealing position of the lubrication fluid is not limited to a position between the inner peripheral surface of the protrusion part 117 and the opposite surface of the sleeve 120.

That is, as shown in FIG. 7A, the lubricating fluid may be sealed between a lower surface of the protrusion part 117 and a surface of the sleeve 120 opposite to the lower surface of the protrusion part 117. In this case, at least one of the lower surface of the protrusion part 117 and the opposite surface of the sleeve 120 may be tapered.

In the case in which the lubricating fluid is sealed between the lower surface of the protrusion part 117 and the opposite surface of the sleeve 120, a storage space for the lubricating fluid may be increased.

During the driving of the spindle motor, the lubricating fluid may be gradually decreased due to leakage or evaporation of the lubricating fluid, or the like, such that a sufficient amount of fluid pressure may not be provided, and thus, the driving of the spindle motor may be severely affected. However, in the spindle motor according to the embodiment of the present invention, the storage space for the lubricating fluid may be sufficiently secured, whereby a lifespan of the spindle motor may be increased.

In addition, as shown in FIG. 7B, in the case in which an interface between the lubricating fluid and air moves between the inner peripheral surface of the protrusion part and the opposite surface of the sleeve according to the evaporation of the lubricating fluid, even when the lubricating fluid is separated from the interface to be leaked by external impacts, or the like, the lubricating fluid may be sealed again due to the taper structure present outwardly thereof.

Therefore, the leakage of the lubricating fluid may be effectively prevented.

Meanwhile, a lower portion of the shaft 111 may be provided with a fixation groove 119, and the stopper member 130 may be fixedly coupled to the fixation groove 119.

The stopper member 130 may include a fixation part 131 inserted into the fixation groove 119 and a flange part 133 extended from the fixation part 131 in the outer radial direction.

The flange part 133 may be extended outwardly of the outer peripheral surface of the shaft in the outer radial direction, and an outer edge of the flange part may be opposite to a lower end of the inner peripheral surface of the sleeve.

Therefore, in the case in which the shaft 111, a component of the rotating member 110, is excessively floated, an upper surface of the flange part 133 may be caught by a lower surface of the sleeve 120, thereby preventing the rotating member 110 from being excessively floated.

In addition, the opposite surfaces of the flange part 133 and the sleeve 120 may be inclined, respectively.

In the case in which the opposite surfaces of the flange part 133 and the sleeve 120 are inclined, the lubricating fluid may more smoothly move within the hydrodynamic bearing assembly.

Therefore, pressure from the lubricating fluid may be effectively dispersed to maintain a balance, and the generation of air bubbles in the lubricating fluid may be suppressed.

In addition, in the case in which the opposite surfaces of the flange part 133 and the sleeve 120 are inclined, a micro clearance between the flange part 133 and the sleeve 120 may be largely divided into three portions according to size.

That is, the size of the micro clearance may be divided into a size of the micro clearance in the axial direction, a size of the micro clearance in a radial direction, and a size of the micro clearance corresponding to the shortest distance between the flange part 133 and the sleeve 120.

Here, when the size of the micro clearance in the axial direction is defined as AC, the size of the micro clearance in the radial direction is defined as RC, and the size of the micro clearance corresponding to the shortest distance between the flange part 133 and the sleeve 120 is defined as SC, SC may be smaller than AC and RC according to the following Equation 1.

AC×COS 45°=SC Equation 1

Therefore, the shortest distance between the flange part 133 and the sleeve 120 may be decreased, as compared with a case in which the opposite surfaces of the flange part 133 and the sleeve 120 are not inclined.

That is, since the micro clearance between the flange part 133 and the sleeve 120 is decreased, in the motor according to the embodiment of the present invention, hydrodynamic pressure may be further increased, and resistance against external impacts, or the like, may be improved.

The cover plate 140 may be coupled to the sleeve 120, while having a clearance from lower portions of the shaft 111 and the sleeve 120.

The cover plate 140 may receive the lubricating fluid in the clearance between the cover plate 140 and the sleeve 120 to support a lower surface of the shaft 111.

In this case, as a method for fixing the cover plate 140, various methods such as a welding method, a caulking method, a bonding method, or the like, may be used, which may be optionally applied according to a structure and a process of a product.

The stator 300 may include the coil 320, the core 330, and a base member 310.

The stator 300 is a fixed structure including the core 330 having the coil 320 wound therearound, wherein the coil 320 generates electromagnetic force having a predetermined magnitude when power is applied thereto.

The core 330 may be fixedly disposed on an upper portion of the base member 310 on which a printed circuit board (not shown) having circuit pattern printed thereon is provided, a plurality of coil holes having a predetermined size and penetrating through the base member 310 maybe formed in an upper surface of the base member 310 corresponding to the core 330 having the coil 320 wound therearound, thereby allowing the coil 320 to be exposed downwardly, and the coil 320 may be electrically connected to the printed circuit board in order to supply external power.

The base member 310 may be manufactured using aluminum in a die-casting scheme or be manufactured by performing plastic working (for example, press working) on a steel sheet.

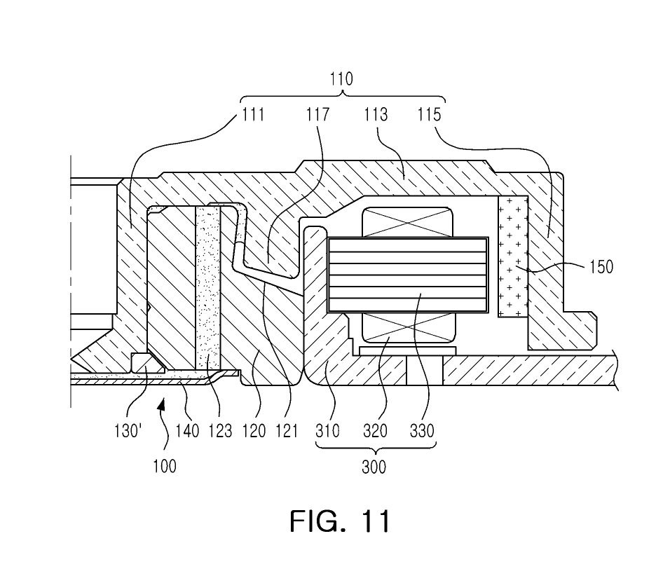

FIG. 11 is a half cross-sectional view of a spindle motor according to another embodiment of the present invention.

Referring to FIG. 11, since the spindle motor according to another embodiment of the present invention is the same as the spindle motor according to the above-described embodiment of the present invention, except for a stopper part 130′, a description thereof except for the stopper part 130′ will be omitted.

In the spindle motor according to another embodiment of the present invention, the stopper part 130′ may be coupled to the lower portion of the shaft 111.

A central portion of the stopper part 130′ may be provided with a hole, and the lower portion of the shaft 111 may be inserted into the hole.

Since an outer edge of the stopper part 130′ may be opposite to an inclined portion formed on the lower portion of the sleeve 120, in the case in which the shaft 111, a component of the rotating member 110, is excessively floated, an upper surface of the stopper part 130′ may be caught by the lower surface of the sleeve 120, thereby preventing the rotating member from being excessively floated.

In addition, opposite surfaces of the stopper part 130′ and the sleeve 120 may be inclined.

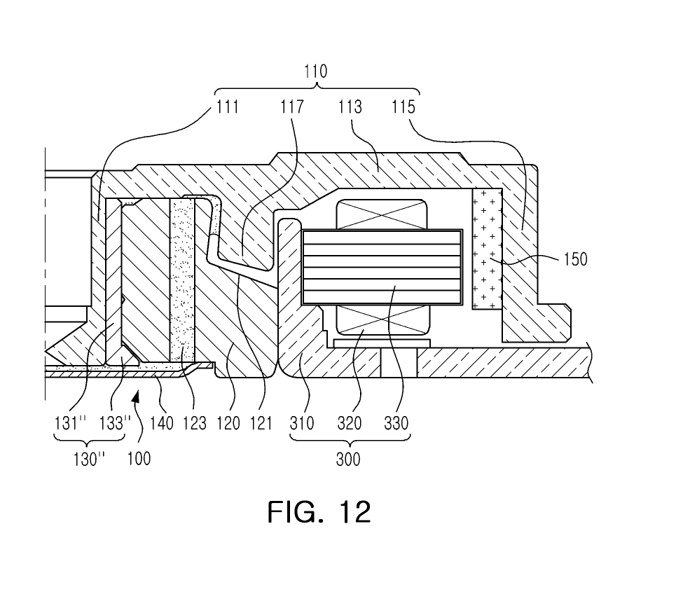

FIG. 12 is a half cross-sectional view of a spindle motor according to another embodiment of the present invention.

Referring to FIG. 12, since the spindle motor according to another embodiment of the present invention is the same as the spindle motor according to the above-described embodiment of the present invention, except for a shaft housing 130″, a description thereof except for the shaft housing 130″ will be omitted.

The shaft housing 130″ may have a hollow cylindrical shape, and the shaft 111 may be inserted into and fixed to a central hole of the shaft housing 130″.

That is, in the spindle motor according to another embodiment of the present invention, the shaft 111 may be fixed to the shaft housing 130″ to configure the rotating member 110 together with the shaft housing 130″.

More specifically, the shaft housing 130″ may include a housing 131″ coupled to the shaft 111 and a stopper part 133″ extended from a lower end of the housing 131″ in the outer radial direction.

Here, the shaft housing 130″ may be inserted into the shaft hole of the sleeve 120 while having a micro clearance therebetween. The micro clearance may be filled with a lubricating fluid, and the rotation of the rotating member 110 may be more smoothly supported by a radial dynamic pressure groove (not shown) formed in at least one of an outer diameter portion of the housing 131″ and an inner diameter portion of the sleeve 120.

The radial dynamic pressure groove may be formed in the inner peripheral surface of the sleeve 120, an inner portion of the shaft hole of the sleeve 120, and generate pressure so that the rotating member 110 may smoothly rotate in a state in which the housing 131″ is spaced apart from the inner peripheral surface of the sleeve 120 by a predetermined interval at the time of rotation of the rotating member 110.

However, the radial dynamic pressure groove is not limited to being formed in the inner peripheral surface of the sleeve 120 as described above, but may also be formed in an outer peripheral surface of the housing 131″. In addition, the number of radial dynamic pressure grooves is not limited.

The radial dynamic pressure groove may have any one of a herringbone shape, a spiral shape, and a helical shape. However, the radial dynamic pressure groove may have any shape as long as radial dynamic pressure may be generated.

Meanwhile, an outer edge of the stopper part 133″ may be opposite to an inclined portion formed on a lower portion of the sleeve 120.

Therefore, in the case in which the shaft 111 and the shaft housing 130″, a component of the rotating member 110, are excessively floated, an upper surface of the stopper part 133″ may be caught by the lower surface of the sleeve 120, thereby preventing the rotating member 110 from being excessively floated.

In addition, opposite surfaces of the stopper part 130″ and the sleeve 120 may be inclined.

As set forth above, according to embodiments of the present invention, the rigidity of a spindle motor may be improved, and a storage space for a lubricating fluid may be increased.

In addition, the number of internal components of the spindle motor may be decreased, such that manufacturing process may be simplified and manufacturing cost may be decreased.

Further, a magnitude of hydrodynamic pressure may be increased, and resistance against external impacts or the like may be improved.

While the present invention has been shown and described in connection with the embodiments, it will be apparent to those skilled in the art that modifications and variations can be made without departing from the spirit and scope of the invention as defined by the appended claims.

What is claimed is:

1. A spindle motor comprising:
a rotating member including a shaft having a fixation groove provided in a lower portion thereof, a hub base extended from an upper end of the shaft in an outer radial direction, and a magnet support part extended downwardly from an outer edge of the hub base in an axial direction;
a sleeve rotatably supporting the rotating member; and
a stopper member including a fixation part inserted into the fixation groove and a flange part extended from the fixation part in the outer radial direction,
wherein opposite surfaces of the flange part and the sleeve are inclined.

2. The spindle motor of claim 1, wherein the flange part is extended outwardly of an outer peripheral surface of the shaft in the outer radial direction, and
an outer edge of the flange part is opposite to a lower end of an inner peripheral surface of the sleeve.

3. The spindle motor of claim 1, wherein the sleeve includes a reception groove depressed downwardly from an upper surface thereof in the axial direction, and
the hub base includes a protrusion part protruding from one surface of the hub base and received in the reception groove.

4. The spindle motor of claim 3, wherein a lubricating fluid is sealed between an inner peripheral surface of the protrusion part and a surface of the sleeve opposite to the inner peripheral surface of the protrusion part.

5. The spindle motor of claim 4, wherein at least one of the inner peripheral surface of the protrusion part and the opposite surface of the sleeve is tapered so as to seal the lubricating fluid.

6. The spindle motor of claim 3, wherein a lubricating fluid is sealed between a lower surface of the protrusion part and a surface of the sleeve opposite to the lower surface of the protrusion part.

7. The spindle motor of claim 6, wherein at least one of the lower surface of the protrusion part and the opposite surface of the sleeve is tapered so as to seal the lubricating fluid.

8. The spindle motor of claim 1, wherein the sleeve is provided with a bypass channel penetrating through upper and lower portions of the sleeve.

9. A spindle motor comprising:
a rotating member including a shaft, a hub base extended from an upper end of the shaft in an outer radial direction, and a magnet support part extended downwardly from an outer edge of the hub base in an axial direction;
a stopper part coupled to a lower portion of the shaft; and
a sleeve rotatably supporting the shaft and including a reception groove depressed downwardly from an upper surface thereof in the axial direction;
wherein the hub base includes a protrusion part protruding from one surface of the hub base and received in the reception groove, and
opposite surfaces of the stopper part and the sleeve are inclined.

10. A spindle motor comprising:
a rotating member including a shaft, a hub base extended from an upper end of the shaft in an outer radial direction, and a magnet support part extended downwardly from an outer edge of the hub base in an axial direction;
a shaft housing including a housing coupled to the shaft and a stopper part extended from a lower portion of the housing in the outer radial direction; and
a sleeve rotatably supporting the shaft and including a reception groove depressed downwardly from an upper surface thereof in the axial direction;
wherein the hub base includes a protrusion part protruding from one surface of the hub base and received in the reception groove, and
opposite surfaces of the stopper part and the sleeve are inclined.

11. The spindle motor of claim 10, wherein at least one of an outer peripheral surface of the housing and an inner peripheral surface of the sleeve is provided with a radial dynamic pressure groove generating radial dynamic pressure.
